(19) United States
(12) Patent Application Publication
(10) Pub. No.: US 2003/0187893 A1
(43) Pub. Date: Oct. 2, 2003

(54) Method of data interpolation with bi-switch slope control scaling

(76) Inventor: Kun-Nan Cheng, Hsinchu (TW)

Correspondence Address: J.C. Patents, Inc., Suite 250, 4 Venture, Irvine, CA, 92618, US

(21) Appl. No.: 10/371,763

(22) Filed: Feb. 21, 2003

Related U.S. Application Data
(60) Provisional application No. 60/369,529, filed on Apr. 1, 2002.

(51) Int. Cl. G06F 7/38

(52) U.S. Cl. 708/290

(57) ABSTRACT

The present invention provides a method of down scaling a source data to generate a destination data. By using 2 source points on a discontinued curve as reference, each piece of destination data can be generated. A midpoint of these 2 neighbor pixels is generated with a slope defined at the midpoint points. It is easy to control the sharpness of the interpolation result by adjusting the gain factor of the slope. The final interpolation curve passes the midpoint point of the 2 neighbor source points with a slope S define at the midpoint point but does not pass the 2 original neighbor pixels. Although the curve is not continuous at the source reference points but it is seen as a smooth curve by the human eyes during scaling down. The curve is a linear equation which makes the computing storage and cost very low. The BSSC method is excellent in scaling down even compared to other high order equation interpolation curve. Furthermore, a Z transform is induced to minimize the computing complexity.

### CROSS-REFERENCE TO RELATED APPLICATION

This application claims the priority benefit of U.S. provisional application titled “BI-SWITCH SLOP CONTROL (BSSC) SCALING” filed on Apr. 1, 2002, serial No. 60/369,529.

### BACKGROUND OF THE INVENTION

1. Field of the Invention

The present invention relates to a method of data interpolation, and more particularly to a method of data interpolation for scaling up or down of different types of data to perform scaling of the source data to the destination data.

2. Description of Related Art

Scaling is useful in graphics, image, video or audio application for expanding or shrinking sample resolution and for zooming. Especially in digital display device with fixed resolution, different kinds of source image format must be scaled to fit the resolution of the digital display.

For example, a display panel may have a fixed resolution of 1024×768 pixels in a XGA mode, but the source image may come from computer, video decoder, or others that the input resolution varies depending on the input modes. The input source in VGA mode (640×480 pixels) with a resolution less than that of the display mode XGA needs to be scaled up when displayed on the XGA panel. On the other hand, an input source in a SXGA mode (1280×1024 pixels) with a resolution greater than that of the display mode XGA needs to be scaled down when displayed on the XGA panel. Image resizing is very important for digital display devices such as liquid crystal display (LCD). Prior art provides different well-known methods such as Bilinear, Cubic, B-Spline, Bésier to achieve a good filtering effect for scaling purposes.

The Bilinear method is the most commonly used method of data interpolation. It benefits in its simplicity, speed, and cost because only two reference points are taken. As a result, the cost of the implementation of the Bilinear method is low because computation and storage requirements are less compared to other high-order interpolation methods. However, the output of the Bilinear method is blurry due to lack of sharpness from the interpolation results and therefore is not suitable for text images. The sharpness of the picture quality depends on curves after fitting the interpolation points. The Bilinear method takes the weighting average as the interpolation result. Consider two neighbor pixels A and B, if the interpolation point C is located between A and B with a distance D (D≦1) from A, then the interpolation result according to the Bilinear method is

C=A(1−D)+BD Eq. 1

Cubic or B-Spline methods are the more preferred methods used in a high quality scaling system with an almost perfect scaling quality, but the cost is very high for computation and storage. Cubic methods usually require 4 points f(−1), f(0), f(1), and f(2) as references. The Cubic Curve using the Hermite Method has one start point P₁, one end point P₂, one start point tangent-vector R₁, and one end point tangent-vector R₂ by the formula

f(x)=(2x³−3x²+1)P₁+(−2x³+3x²)P₂+(x³−2x²+x)R₁+(x³−x²)R₂ Eq. 2

=(2P₁−2P₂+R₁+R₂)x³+(−3P₁+3P₂−2R₁−R₂)x₂+R₁x+P₁ Eq. 3

where

P₁=f(0),

P₂=f(1)

R₁=G₁(P₂−P₀)/2=G₁[f(1)−f(−1)]/2=tangent-vector at P1

R₂=G₂(P₃−P₁)/2=G₂[f(2)−f(0)]/2=tangent-vector at P2

G₁, G₂ are gain factors, wherein gain factor is proportional to the sharpness of the scaling result.

The Bésier curve is also famous, and used in many applications like the curve fitting, 2D boundary, or 3D surface . . . etc. The Bésier curve uses 4 points, P₁, P₂, P₃,P₄ as the control points. It indirectly specifies an endpoint tangent vector by specifying two intermediate points that are not on the curve. The starting and ending tangent vectors are determined by vector P₁P₂ and P₃P₄ and are related to R₁ and R₄ by

R₁=f′(0)=3(P₂−P₁), R₄=f′(1)=3(P₄−P₃) Eq. 4

f(x)=(1−x)³P₁+3x(1−x)²P₂+3x²(1−x)P₃+x³P₄ Eq. 5

In the field of scaling down the source data to destination data, the even and uniform result is preferred that is not the same as scaling up case that needs sharper result.

### SUMMARY OF THE INVENTION

The present invention provides a low cost and high performance scaling algorithm of a bi-switch slope control scaling (BSSC) method for both shrinking and zooming purposes by a linear equation. The quality of the BSSC method can be compared with the Cubic or B-Spline methods, while keeping the cost approximately equal to that of the Bilinear method. The BSSC method of the present invention only requires two reference points so therefore computation and storage requirement are less than that of Cubic or B-Spline methods and equal to the minimal size of Bilinear method. Each piece of destination data can be generated only with 2 source points as reference. A slope control is used to control the sharpness of the interpolation result. The interpolation curve starts from any one of a set of 2 neighboring source points. After the interpolation points are located by the first set of 2 neighboring source points, consecutive sets of 2 neighboring points will be taken until all the reference points are used. The slope defining the straight line which passes through the two neighboring points and crossing a midpoint of the two neighboring points is S. Different midpoint point slope gain DG affects the scaling quality, and can be adjustment according the different scaling requirement. Also, a Z transform is induced to further minimize the computing complexity.

It is to be understood that both the foregoing general description and the following detailed description are exemplary, and are intended to provide further explanation of the invention as claimed.

### BRIEF DESCRIPTIOIN OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic diagram illustrating a curve using a bi-switch slope control scaling (BSSC) scaling method of a preferred embodiment of the present invention;

FIG. 2 is a schematic diagram illustrating the behavior using the BSSC scaling method with a different gain of a slope at a start source point in a preferred embodiment of the invention; and

FIG. 3 is a schematic diagram illustrating the result of scaling with a scaling factor of 1.25 in an embodiment of the invention.

### DETAILED DESCRIPTION OF THE PREFERRED EMBODIEMENTS

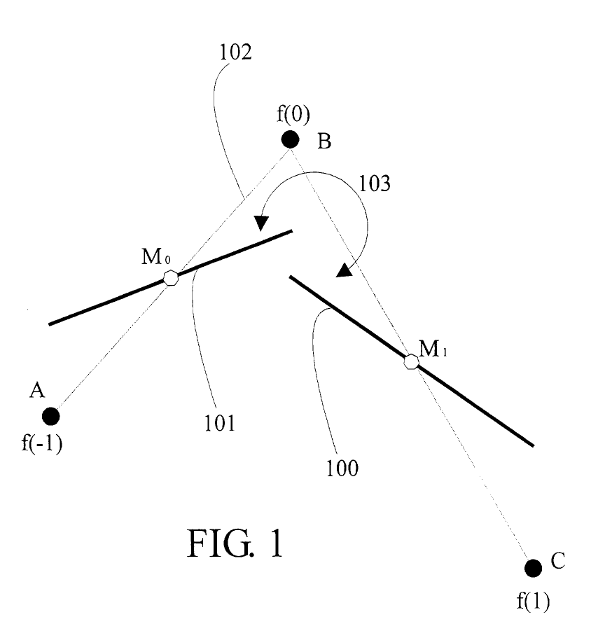

FIG. 1 shows a curve using a bi-switch slope control scaling (BSSC) method of a preferred embodiment of the present invention for scaling. An input curve f(x) is provided, which can be discontinuous, as an input source data. Several reference source points are also provided as references for scaling. Reference numbers 100 and 101 indicate different segments of the input curve, where the curves pass through a midpoint of different sets of two reference points.

Advantages of the BSSC method are low-cost, simple circuitry, and less quality loss compared to other high-order (3'rd or more) interpolation methods. It uses only two samples f(0), f(1) to generate a scaling result but is able to produce a much sharper image than that of the Bilinear method. It is especially useful in the case when finite storage is implemented. In common applications, during vertical scaling the entire line of source image sample data must be stored in a line buffer. Therefore, more source points require more storage capacity which increases the cost. The BSSC method of the present invention only requires two samples which means that only two line buffers are needed for scaling such as zooming or shrinking. A gain factor G affects the quality of scaling, where G>1 is generally considered good for scaling purposes. Please note that G≠1 because this case will be the same as the Bilinear method.

Referring to FIG. 1, the curve 101 is the curve using in the BSSC method. The curve 100 passes the midpoint M₁, while the curve 101 passes the midpoint M₀. The points A, B, C are the source points. A curve 102 is a bilinear curve for comparison. There is a disconnect 103 at a boundary of the curve 100 and 101, which is a major feature of the BSSC method. For any curve f(x), the theory behind the present invention is as follow:

Given f(x)=bx+c Eq. 6

f′(x)=b Eq. 7

Assume f(0) and f(1) are the source image points and M₁ is the midpoint of f(0) and

f(1), ie. M₁=0.5[f(0)+f(1)] Eq. 8

then the curve passes the midpoint M₁ with a start point slope f′(0.5)

Define:

DG: midpoint slope=f′(0.5)=(f(1)−f(0))G Eq. 9

G is gain factor, 0<G<1.

f′(0.5)=b=DG=(f(1)−f(0))G Eq. 10

f(0.5)=M₁=0.5[f(0)+f(1)]=0.5b+c Eq. 11

the solution of f(x) in 0≦x<1 will be

f(x)=DGx+(M₁−0.5DG) Eq. 12

=DGx+0.5[f(0)+f(1)−DG] Eq. 13

The BSSC method of the present invention has superior performance in shrinking applications comparable to the famous Beta-Spline or Bésier method but at a very low cost. By only using two sample points, only two line buffers are required for storage during vertical scaling which can significantly reduce the size and cost of memory. In order to further reduce the cost, a Z-transformation is applied to the equations.

F(z)=bz+c Eq. 14

F′(z)=b; Eq. 15

Z(z)=X(x)−0.5 Eq. 16

i.e.

Z(−0.5)=X(0) Eq. 17

Z(0)=X(0.5) Eq.18

Z(0.5)=X(1) Eq. 19

Thus an initial condition is:

F′(0)=b=DG=(f(1)−f(0))G, Eq. 20

F(0)=c=0.5[f(0)+f(1)]=M Eq. 21

F(z)=DGz+M Eq. 22

=DGz+0.5[f(0)+f(1)] Eq. 23

The cost estimation for using the Z transformation is as followed:

| | Parameters | Adder | Multiplier | Note |
|---|---|---|---|---|
| Before Z | DG = [ƒ(1) − ƒ(0)]G | 1 | 1 | |
| transform | b = DG | 0 | 0 | Share with |
| | | | | DG |
| | c = 0.5[ƒ(0) + ƒ(1) − DG] | 2 | 0 | |
| | Total | 3 | 1 | |
| After Z | DG = [ƒ(1) − ƒ(0)]G | 1 | 1 | |
| transform | b = DG | 0 | 0 | Share with |
| | | | | DG |
| | c = 0.5[ƒ(0) + ƒ(1)] | 1 | 0 | |
| | Total | 2 | 1 | |

By applying a simple Z transformation on the equations above, the number of adders is brought down to two from its original three. However, due to the fact that true color requires 3 separate R, G, B channels in a display system, this means 3 sets of (x) are needed. Since x denotes the position, the three sets are identical so only one set of f(x) will be discussed. The transformation can just be implemented by, for example, a method of bit mapping. In such method of bit mapping, 0.5 is a suitable value for implementation. For example, a binary code 00000 can denote “0”, a binary code 10000 cab denote “0.5”, a binary code 01000 can denote “0.25”, and a binary code 11000 can denote “0.75”, etc. In the embodiment of employing the simple bit mapping, the transformation needs at most just a half of the number of adders for implementation.

Thus, the Z transformation employed in the BSSC Scaling method of the preferred embodiment can reduce the number of adders from three to two for parameters a, b, c calculation. The cost of the multiplier can be cut down by using a shifter (ie 4X, 2X, 1X, 0.5X, 0.25X), therefore the cost will only depend on the number of adders. This will enhance the importance of Z transformation, which reduces the number of the adders from three to two.

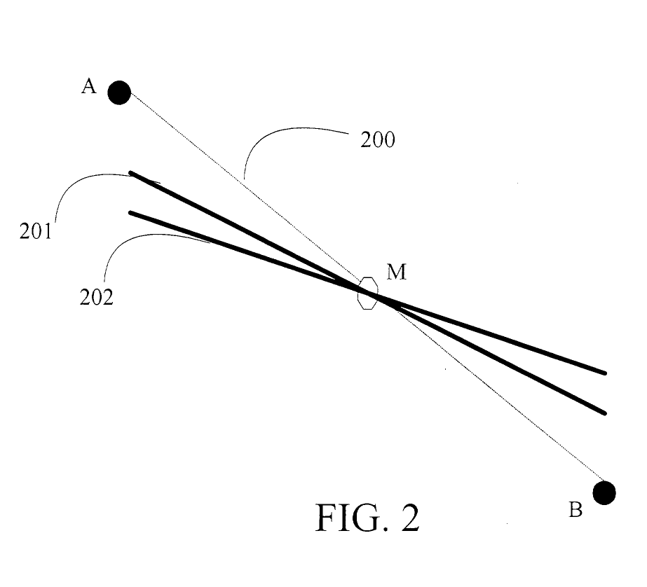

FIG. 2 shows the behavior of BSSC scaling method with different gains of slopes at start source points of the present invention. The curve 200 is a bilinear curve shown for comparison. The curves 201 and 202 are the curves using the BSSC method at a midpoint M. A slope gain G of the curve 201 is greater than a slope gain G of the curve 202 and 1>G>0 for the curves 201 and 202. The slope gain G≠1, and the slope is DG=[f(1)−f(0)]G, for 0≦x<1.

The adjustment of the gain G is like turning a switch and for this is the reason that the method is called “Bi-Switch”. For good shrinking quality, G is typically smaller than 1. It is noted that the curve is not continuous in the source sample points f(n), n=0,1 . . . M, where M is an integer. During shrinking applications, the distance between two neighboring interpolated points is greater than that of the two original source sample points, i.e., the distance is larger than 1. As a result, the discontinuity is smoothed by the human eye because not all the curves but only the interpolated points can be seen. Thus, the quality of the BSSC method of the preferred embodiment of the invention is good with homogeneous and smooth result compared to other scaling methods.

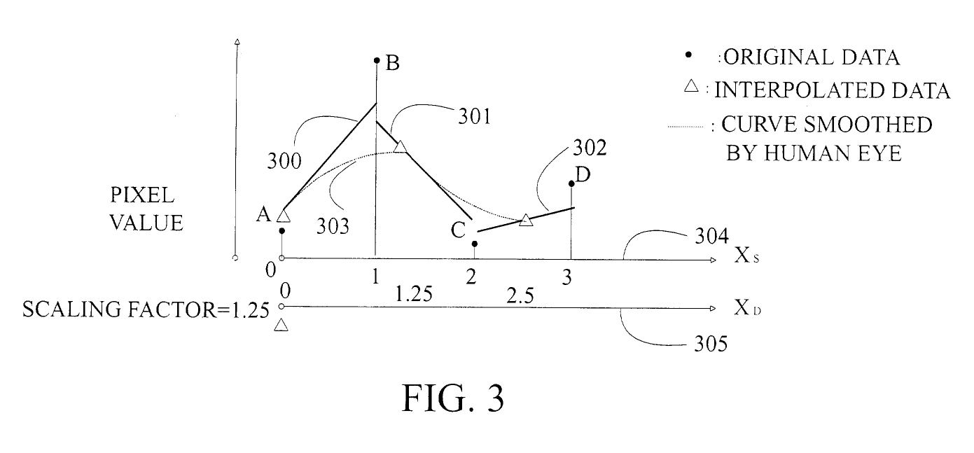

FIG. 3 shows an implementation of the BSSC method of a preferred embodiment of the invention. Points A, B, C, D are source points. Input curves 300, 301 and 302 are different sections of a discontinued curve using the BSSC method. The resulting curve 303 however is smoothened by the human eye because of the interpolated result from the interpolated points. A coordinate 304 (X_{S}) is a coordinate representing source data locations, and a coordinate 305 (X_{D}) is a coordinate representing destination interpolation data locations. For zooming and shrinking purposes, the procedure is described as follow:

a. X_{S} denotes the position coordinate, where original data D₀, D₁, D₂, D₃ . . . D_{M} are located in x=0, 1, 2, 3 . . . , M

b. A scaling factor generator generates the interpolation data location X_{D}. The scaling factor is decided by (input resolution)/(output resolution), and 1.25 is used in this embodiment. If the scaling factor is smaller than 1, it represents operation of up scaling is required, and if the scaling factor is larger than 1, it represents operation of down scaling is required. For interpolation points x located between the coordinate x=N to x=N+1.

given f(0)=D_{N}

f(+1)=D_{N+1}

and x=0 . . . 1 (truncate the integer part N)

c. Apply DG, 1>G>0

DG=[f(1)−f(0)]G

d. Apply

f(x)=DGx+0.5[f(0)+f(1)−DG]

for the range x=0 . . . 1

, or use the Z transformation,

Z(z)=X(x)−0.5

F(z)=DGz+0.5[f(0)+f(1)]

e. Calculate the f(x) or F(z), where f(x) and F(z) respectively denote the data after shrink at point x.

The BSSC scaling method of the present invention is low cost and high performance in scaling operation compared to the well-known method Cubic or B-Spline method. By defining the midpoint slope and gain DG, the scaling quality can be controlled and adjusted. The computation, processing, and storage requirement are only a little greater than that of the conventional Bilinear method but considerably less than that of the conventional Cubic or B-Spline methods because the BSSC scaling method only requires two reference points. Furthermore, a smooth image is achieved in scaling down a source image as compared to the blurry image output using the Bilinear method. It is very important during vertical scaling that the whole line of image data must stored as a whole in the line buffer. The more the reference points, means more line buffers are required but the BSSC method of the present invention only requires a minimum of two line buffers for two reference points. The present invention is excellent in many applications like in scaling of graphic, image, video, audio, or polygon curve fitting applications, moving tracking analysis, data analysis, or finder for object 2D shape or 3D surface in graphic area.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of interpolating data for scaling a source signal to a destination signal, the method comprising:
receiving the source data from an input curve f(x);
selecting two reference points from the received source data;
finding a midpoint between the two reference points;
calculating a slope of the midpoint and applying a gain factor to the midpoint slope;
finding a solution to the input curve f(x) in terms of the two reference points and the gain factor;
using the solution to calculate and generate a plurality of interpolation points based on a scaling factor; and
fitting the input curve f(x) with the interpolation points.

2. The method of claim 1, wherein the step of finding the solution further comprising applying a Z-transformation to the solution.

3. The method of claim 1 further comprising applying initial conditions to the input curve f(x) for the two reference points.

4. The method of claim 1, wherein the gain factor is between zero and one.

5. A method of interpolating data for scaling a source signal to a destination signal, the method comprising:
receiving the source data from an input curve f(x);
selecting two reference points f(0) and f(1) from the source data;
defining a midpoint M between the two selected reference points f(0) and f(1);
calculating a slope of the midpoint M and applying a gain factor with an equation as f′(0.5)=[f(1)−f(0)]G=DG, wherein G is a gain factor and D is a midpoint slope of the midpoint M;
finding a solution of the input curve f(x) by equations:
f(x)=DGx+(M−0.5DG)
=DGx+0.5[f(0)+f(1)−DG] for 0<x<1,
where the midpoint M=0.5[f(0)+f(1)]
using the solution to calculate and generate a plurality of interpolation points based on a scaling factor; and
fitting the input curve f(x) with the interpolation points.

6. The method of claim 5 further comprising applying initial conditions to the input curve f(x) for the two selected reference points with equations:
for 0≦G<1
f′(0.5)=b=DG=(f(1)−f(0))G
f(0.5)=M=0.5[f(0)+f(1)]=0.5b+c,
wherein M is the midpoint, D is the midpoint slope, and G is the gain factor.

7. The method of claim 5, wherein the gain factor is between zero and one.

8. A method of interpolating data for scaling a source signal to a destination signal, the method comprising:
receiving the source data from a input curve f(x);
locating a plurality of reference points from the source data;
selecting two of the reference points f(0) and f(1) from the reference points;
finding a midpoint M between the two selected reference points f(0) and f(1);
calculating a slope of the midpoint M and applying a gain factor with an equation
f′(0.5)=[f(1)−f(0)]G=DG,
wherein G is the gain factor and D is the midpoint slope;
finding a solution to the input curve f(x) using a Z transformation procedure, wherein the Z(z)=X(x)−0.5 by equations:
F(z)=DGz+M
=DGz+0.5[f(0)+f(1)] for −0.5z<0.5,
where the midpoint M=0.5 [f(0)+f(1)]
using the solution of the input curve f(x) by the Z transformation procedure to calculate and generate a plurality of interpolation points based on a scaling factor; and
fitting the input curve f(x) with the interpolation points.

9. The method of claim 8 further comprising applying initial conditions to the input curve f(x) for the two selected reference points with equations:
for −0.5≦z<0.5,
F(0)=c=0.5[f(0)+f(1)]=M,
F(z)=DGz+M.

10. The method of claim 9, wherein the gain factor is between zero and one.

11. A method for interpolating data especially scaling a source signal to a destination signal where f(0) and f(1) are the reference points and f′(0.5)=[f(1)−f(0)]G=DG is a slope of a midpoint of the two reference points f(0) and f(1), wherein G is a gain factor and D is a midpoint slope of the midpoint, the method comprising:
applying the gain factor to the calculated midpoint slope;
finding a solution to the input curve f(x) by equations:
f(x)=DGx+(M−0.5DG) or
=DGx+0.5[f(0)+f(1)−DG] for 0≦x<1; and
using the solution to calculate and generate a desired number of interpolation points based on a scaling factor.

12. The method of claim 11, wherein the gain factor is between zero and one.

13. A method for interpolating data especially scaling a source signal to a destination signal where f(0), f(1) are the reference points and f(0.5)=[f′(1)=f(0)]G=DG is the slope, wherein G is a gain factor and D is a midpoint slope, the method comprising:
applying the gain factor to the calculated midpoint slope;
finding a solution to the input curve f(x) by equations:
F(z)=DGz+M or
=DGz+0.5[f(0)+f(1)] for −0.5≦z<0.5,
wherein G is the gain factor and D is the midpoint slope; and
using the solution to calculate and generate a desired number of interpolation points based on a scaling factor.

14. The method of claim 13, wherein the gain factor is between zero and one.
